(19) United States
(12) Patent Application Publication
(10) Pub. No.: US 2014/0230068 A1
(43) Pub. Date: Aug. 14, 2014

(54) SYSTEM AND METHOD FOR PACKAGING AND AUTHENTICATING A SOFTWARE PRODUCT

(71) Applicants: Rajendra Rao Kundapur, Fremont, CA (US); Pavan Rabindranath Bolar, Bangalore (IN)

(72) Inventors: Rajendra Rao Kundapur, Fremont, CA (US); Pavan Rabindranath Bolar, Bangalore (IN)

(21) Appl. No.: 13/765,629

(22) Filed: Feb. 12, 2013

(51) Int. Cl. G06F 21/10

(52) U.S. Cl. CPC G06F 21/10
USPC 726/26

(57) ABSTRACT

A software product unique to a user includes (i) one or more software components that is executed on a computing environment associated with the user. The one or more software components include an imprinted entitlement data that is imprinted within at least one of (a) a data section, and (b) an instruction section. An entitlement data monitoring module is configured to authenticate the imprinted entitlement data for an execution of the one or more software components on the computing environment. Based on a validity of the imprinted entitlement data, at least one of (i) the one or more software components of the software product is activated or deactivated, and (ii) a representative associated with monitoring the validity of the imprinted entitlement data of the software product is notified.

### BACKGROUND

1. Technical Field

The embodiments herein generally relate to software products, and, more particularly, to a system and method for packaging and authenticating a software product.

2. Description of the Related Art

Software packages published by a software vendor are typically a collection of software components in which source code is compiled, linked and binaries are clubbed together as an executable archive. All the software components are constructed or packed into a single common package and then made available for publishing. A security key which activates software is generated separately for a particular package and for a specific customer and distributed separately from the package.

Software piracy has become prevalent. Providing a separate product key for the software package enhances a certain amount of safety from illegal use. However, it is relatively easy to create a counterfeit product key that exists separately from the package, and illegally make a copy of the software package and use it when it not entitled for specific users or a company. When an illegal copy of software components and/or counterfeit product key is examined, it becomes impossible to track or identify to whom the software package or components was originally entitled or issued to. Thus, it is difficult to trace the entitlement or legitimacy of the use of the software package when the product keys and the software are illegally used.

FIG. 1 illustrates a block diagram of a typical software component 102, a product key 104, and a software product 106. The block diagram includes the product key 104 to activate the software component 102. The software product 106 is constructed with one or more software components. The product key 104 for activating the software component 102 is delivered as separate entity to a computing environment.

FIG. 2 illustrates a block diagram of a typical software product distribution to a computing environment 204. The block diagram includes the software product 106 having the software component 102, and a database 202. The computing environment 204 communicates with a software vendor to provide a requested software product and to authenticate the requested software product to use within the computing environment 204. The requested software product 106 is retrieved and delivered to the computing environment 204. The product key 104 for the software product 106 is either (i) published via internet and delivered to the computing environment 204, or (ii) delivered in a form such as computer readable medium(e.g., stored on a DVD, CD, or any other such media). The software product 106 is made available to all customers to unpack, execute and use the software product 106 as per the product key 104. Along with the software product 106, the computing environment 204 receives the product key 104, which is, typically in form of a label or a license file, or a sticker present on the computer readable medium. The product key 104 is sometimes provided to the computing environment 204 over an Interactive Voice Response (IVR), or an email to activate the software component 102. The product key 104 is used to activate the software product 106 on the computing environment 204 (e.g., a personal computer or a laptop) to control software entitlement and prevent piracy. However, hacking is very easy when the product key 104 is provided separately to the computing environment 204. Accordingly, there remains a need for a system to prevent a software piracy.

### SUMMARY

In view of the foregoing, an embodiment herein provides a software product unique to a user. The software product includes one or more software components that are executed on a computing environment associated with the user. The one or more software components include imprinted entitlement data that is imprinted within at least one of (a) a data section and (b) an instruction section. Based on a validity of the imprinted entitlement data at least one of (i) the one or more software components of the software product is activated or deactivated, and (ii) a representative associated with monitoring the validity of the imprinted entitlement data of the software product is notified.

The software product may include one or more entitlement data monitoring module that is imprinted within the software product. The entitlement data monitoring module is configured to authenticate the entitlement data for the execution of the one or more software components on the computing environment. The software product may further include the one or more entitlement data monitoring module imprinted within the instruction section of the one or more software components of the software product. The representative may be notified and continues with execution of the one or more software components of the software product in the computing environment when the imprinted entitlement data found to be invalid. The entitlement data may includes (i) information associated with the user, (ii) information associated with the computing environment, (iii) contract terms and conditions, and (iv) validity period of the one or more software components of the software product or a plurality of other software product and associated software components within the computing environment. The contract terms and conditions may includes (i) an agreement associated with the software product, (ii) information to enable the one or more software components for a specific time period, (iii) the information to enable specific functionality of the one or more software components, (iv) the information to enable the one or more software components until termination of the agreement, and (v) the information to secure the one or more software components from tampering and illegal use.

In another aspect, a method of imprinting an entitlement data within a software product. The method includes (a) processing the entitlement data associated with a computing environment information from a user. The entitlement data includes an end user information and a license file associated with the software product. (b) obtaining a unique code that is generated based on the entitlement data associated with the computing environment the user. (c) imprinting the unique code within one or more (i) a data section and (ii) an instruction section of said software product. The one or more entitlement data is unique to the user and the computing environment associated with the user.

The method may further include imprinting at the imprinting system, one or more entitlement data monitoring module within the software product. The one or more entitlement data monitoring module is configured to authenticate the entitlement data for the execution of the one or more software components on the computing environment, or other software products and associated components within the computing environment. The imprinting may further includes imprinting the one or more entitlement data monitoring module within one or more instruction section of the software component of the software product.

In yet another aspect, a non-transitory program storage device readable by computer, and includes a program of instructions executable by the computer to perform a method of authenticating an entitlement data imprinted within a software product. The method includes (a) detecting an execution of one or more software components of the software product within a computing environment. (b) comparing a imprinted entitlement data imprinted within the one or more software components of the software product with an information associated with the computing environment, and (i) activating or deactivating the one or more software components of the software product within the computing environment based on the imprinted entitlement data; or (ii) notifying an representative associated with monitoring of said authenticating of said imprinted entitlement data of said software product.

The method may further include continuing with execution of the one or more software components of the software product in the computing environment when the representative notified with the imprinted entitlement data of the software product is invalid. The imprinted entitlement data may include one or more (i) end user information (ii) a license file, and (iii) combination thereof. The imprinted entitlement data may be encrypted to authenticate and detect a tampering of the one or more software components. The imprinted entitlement data may be imprinted within (i) one or more data section, (ii) one or more instruction section, or (iii) the one or more data section and instruction section.

The license file may include one or more (a) a contract terms and conditions that includes an entitlement contract expiration data, (b) a validity period of one or more software components, (c) information associated with the software product and associated functionalities, (d) information associated with the computing environment, (e) information associated with a user, (f) information associated with a version of the software product, and (g) information associated with number of instances the software product to be used.

The imprinted entitlement data of the software product may be authenticated by (a) extracting an encrypted imprinted entitlement data from the one or more software components, (b) verifying digital signature of the imprinted entitlement data in the one or more data section and the instruction section by using a public/private encryption keys, and (c) decrypting the imprinted entitlement data for verifying tampering on one or more software components. The tampering is verified based on a digitally signed imprinted entitlement data of the software product. The activating or deactivating the one or more software components within said computing environment may includes decrypting the imprinted entitlement data to validate contract terms and conditions of the one or more software components, (i) deactivating the one or more software components from use by including a contract termination, or (ii) notifying the representative associated with monitoring of the authenticating of the imprinted entitlement data of the software product.

The method may further include activating or deactivating of associated functionalities based on decrypted imprinted entitlement data. The imprinted entitlement data may be decrypted to activate a subset of the associated functionalities within the one or more software components. The method may further include activating or deactivating specific functionalities within other software products and associated software components executed within the computing environment. The method may further include authenticating of entitlement expiration based on decrypted imprinted entitlement data. The imprinted entitlement data may be decrypted to deactivate one or more software components and the subset of associated functionalities.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which

FIG. 1 illustrates a typical block diagram of a software component, a security key, and a software product;

FIG. 2 illustrates a block diagram of a typical software product distribution to a computing environment;

FIG. 3 illustrates a block diagram of packaging one or more software products, and distributing the one or more software products to one or more user devices, and authenticating the one or more software products during an execution on one or more computing environment associated with the one or more user devices according to an embodiment herein;

FIG. 4A illustrates an exemplary view of an entitlement data in an unencrypted format according to an embodiment herein;

FIG. 4B illustrates an exemplary view of the entitlement data of FIG. 4A in an encrypted format according to an embodiment herein;

FIG. 5 illustrates an exploded view of the software component of FIG. 3 according to an embodiment herein;

FIG. 6 illustrates an exploded view of the entitlement data validation system of FIG. 3 according to an embodiment herein;

FIG. 7 is an interaction diagram illustrating a method of creating a software product based on an information received from the one or more computing environment according to an embodiment herein;

FIG. 8 is an interaction diagram illustrating a method of authenticating the software product during an execution within the one or more computing environment according to an embodiment herein;

FIGS. 9A & 9B is a flow diagram illustrating imprinting the entitlement data and the entitlement data monitoring module within a software product according to an embodiment herein;

FIGS. 10A & 10B is a flow diagram illustrating a method of authenticating the entitlement data of the one or more software components in the one or more computing environment according to an embodiment herein;

FIG. 11 is a process view illustrating a method of authenticating other software products using the entitlement data according to an embodiment herein;

FIGS. 12A & 12B is a flow diagram illustrating a method of authenticating and executing the other software products and associated the one or more software components, using the entitlement data monitoring module of the software product based on the entitlement data according to an embodiment herein;

FIG. 13 is a flow diagram illustrating a method of imprinting an entitlement data within the software product; and

FIG. 14 is a flow diagram illustrating a method of authenticating entitlement data imprinted within the software product;

FIG. 15 illustrates an exploded view of the user device of FIG. 3 according to an embodiments herein; and

FIG. 16 illustrates a schematic diagram of a computer architecture used in accordance with the embodiment herein.

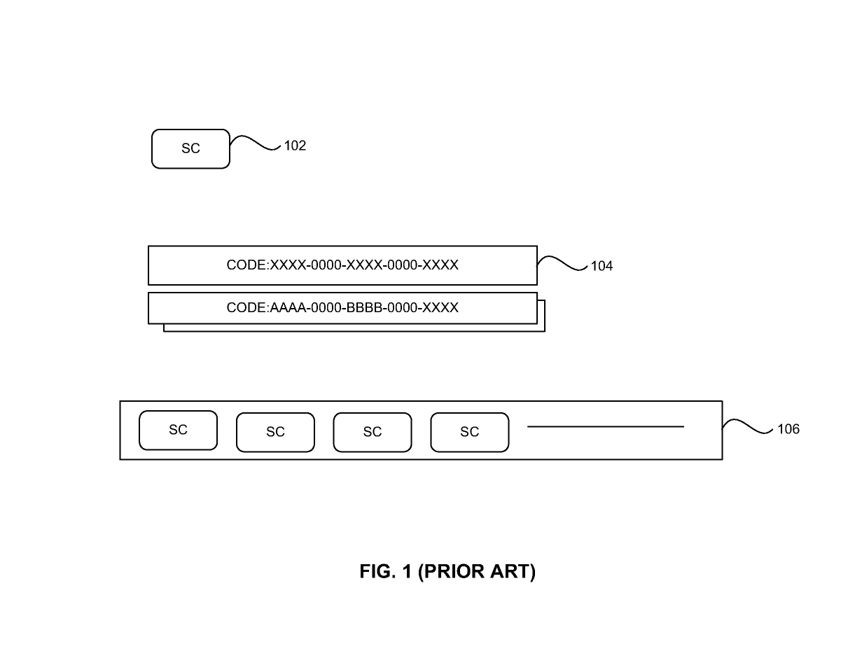

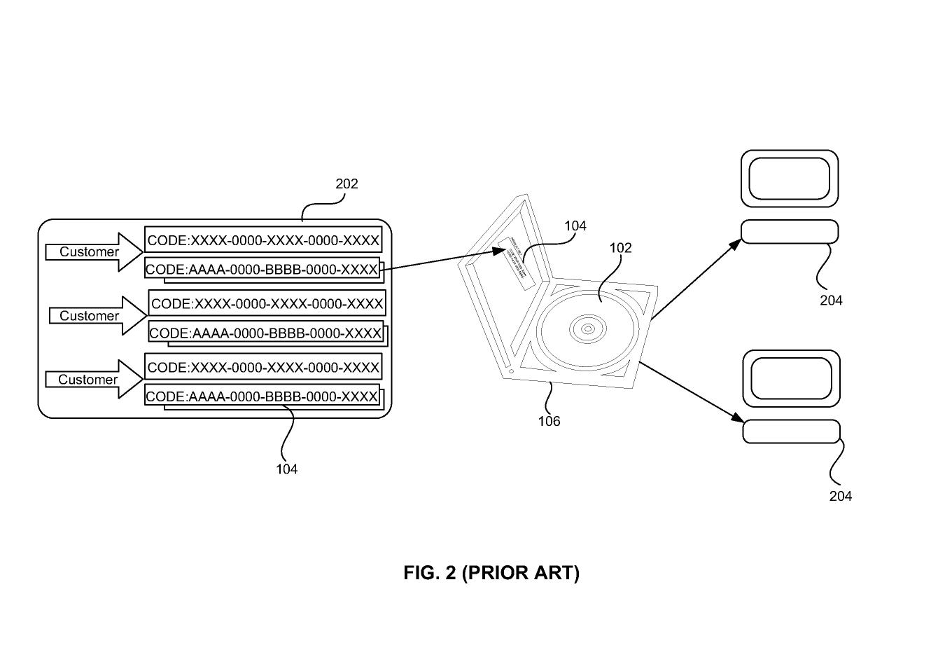

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

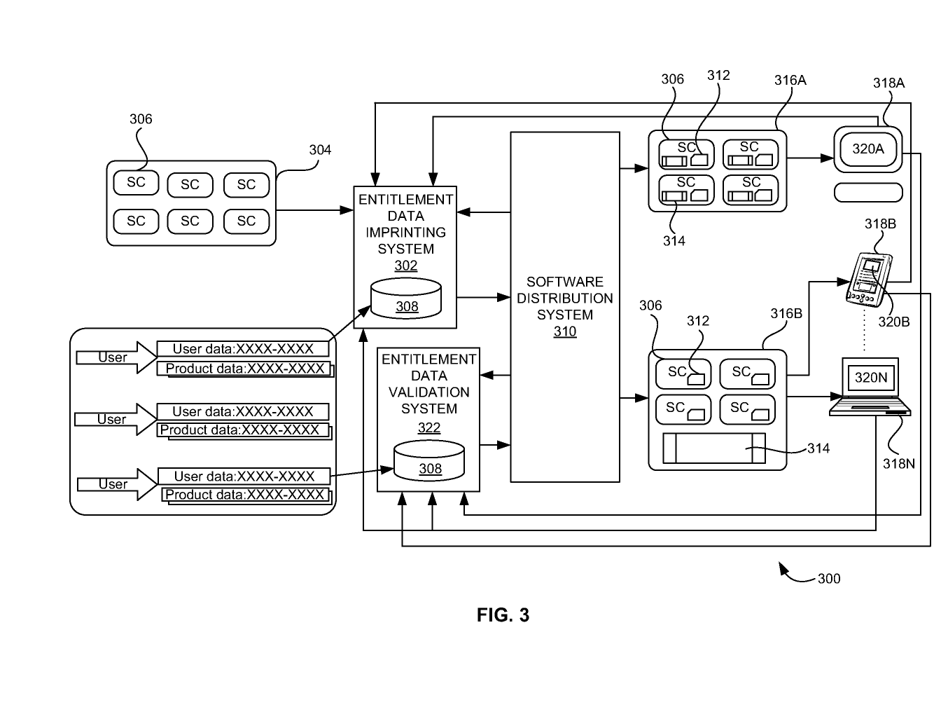

As mentioned, there remains a need for a system to prevent software piracy. The embodiments herein achieve this by providing a system and method of imprinting one or more software components with an entitlement data and authenticating to create a unique software product for a specific user. Referring now to the drawings, and more particularly to FIG. 3 through FIG. 16, where similar reference characters denote corresponding features consistently throughout the figures, preferred embodiments are shown.

FIG. 3 illustrates a block diagram of packaging one or more software products, and distributing the one or more software products to one or more user devices 318A-N, and authenticating the one or more software products during an execution one or more computing environment 320A-N associated with the one or more user devices 318A-N according to an embodiment herein. The block diagram includes a entitlement data imprinting system 302, a software product 304 that includes one or more software components 306, a database 308, a software distribution system 310 and an entitlement data validation system 322. A user requests for a delivery of the software product 304 by providing details associated with (i) the user, (ii) a hardware infrastructure of a user device, (iii) a computing environment of the user device, and/or (iv) combinations thereof, to the entitlement data imprinting system 302. The user may provide the details to the software distribution system 310 which communicates the details to the entitlement data imprinting system 302.

The entitlement data imprinting system 302 obtains a unique code that is generated based on the details provided by the user and the database 308. The unique code includes at least one entitlement data 312 associated with the software product 304. An end user information and a product identifier (e.g., a license file) together constitute an entitlement data 312. The unique code may be generated in real time, in one example embodiment. The unique code may be generated either by the entitlement data imprinting system 302, or by a third party system, in another example embodiment. The unique code may be generated based on the combinations of the details processed from the user, in yet another example embodiment.

The entitlement data imprinting system 302 imprints/embeds the unique code and an entitlement data monitoring module 314 within the software product 304. The entitlement data imprinting system 302 may imprint the unique code within the one or more software components 306, in one example embodiment. The unique code may be imprinted within (i) at least one data section, (ii) at least one instruction section, or (iii) the at least one data section and the at least one instruction section of the one or more software components 306. The entitlement data monitoring module 314 may be imprinted within the at least one instruction section of the one or more software components, in one example embodiment.

The database 308 stores (a) details associated with (i) one or more users, (ii) a hardware infrastructure of the one or more user devices 318A-N, (iii) one or more computing environment 320A-N of the one or more user devices 318A-N, and/or (b) one or more unique codes that are specific to the one or more users. The software distribution system 310 receives the software product from the entitlement data imprinting system 302 and distributes to the user. The entitlement data imprinting system 302 may directly deliver the software product to the user, in one example embodiment herein.

In case, when the unique code and the entitlement data monitoring module 314 are imprinted within the software product, by the third party system, the third party system may directly deliver the software product to the user without an intervention of the entitlement data imprinting system 302 and the software distribution system 310. A software product 316A and a software product 316B which are delivered/distributed to corresponding the one or more user device 318A-N as shown in FIG. 3, includes the entitlement data 312, and the entitlement data monitoring module 314.

The software product 316A includes the one or more software components 306. Each of the one or more software components 306 are imprinted with the at least one entitlement data, and the entitlement data monitoring module 314, in one example embodiment. The software product 316B includes the one or more software components 306. Each of the one or more software components 306 are imprinted with the at least one entitlement data. The entitlement data monitoring module 314 may be imprinted within the software product 316B itself, in another example embodiment.

An execution of the one or more software components 306 on the one or more computing environment 320A-N of the one or more user devices 318A-N is enabled and controlled based on the at least one entitlement data. The at least one entitlement data is unique to the user and at least one computing environment (e.g., the computing environment 320A, the computing environment 320B, and the computing environment 320N) associated with the user. The entitlement data monitoring module 314 is configured to authenticate the at least one entitlement data for the execution of the one or more software components 306 within the computing environment. The one or more user devices 318A-N may be a personal computer, a laptop, an Ultra book, a mobile communication device, a personal digital assistant (PDA), a tablet PC, a smart phone, and/or any other such computing device, etc.

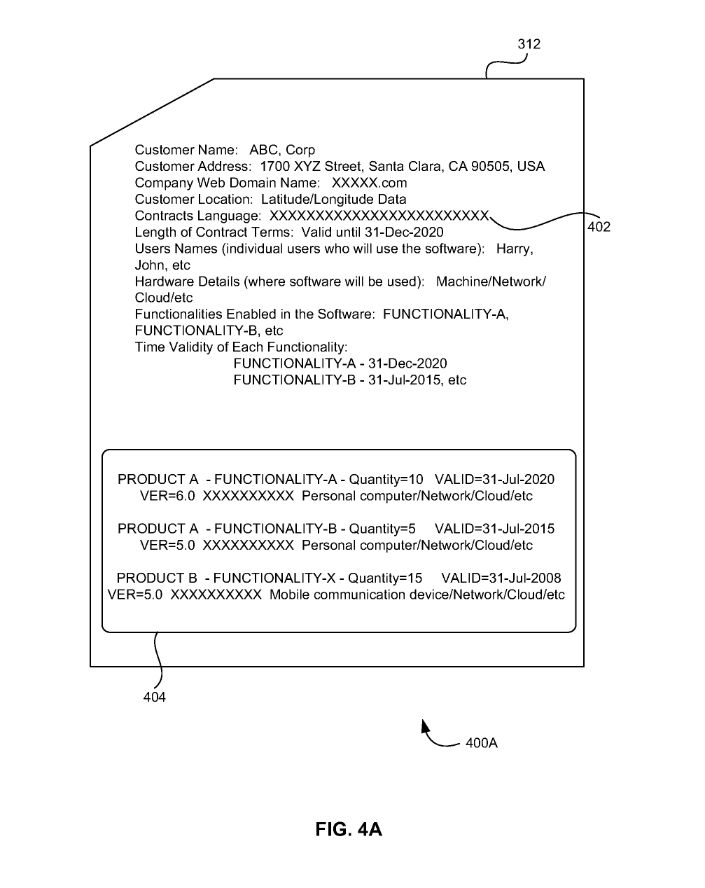

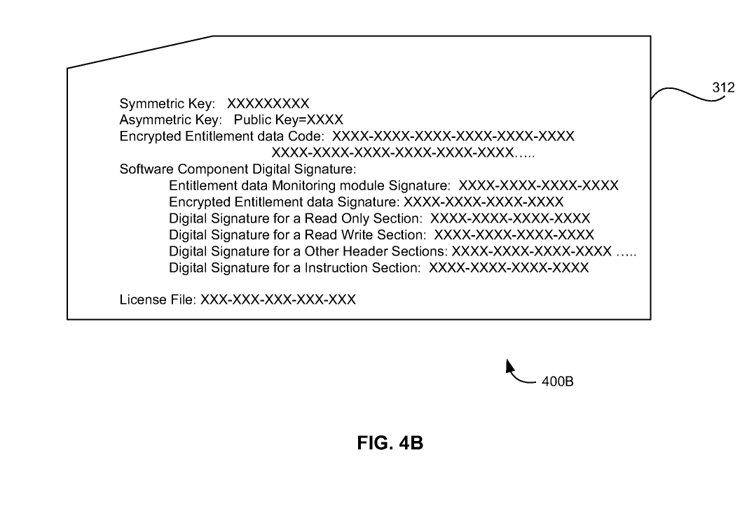

FIG. 4A illustrates an exemplary view 400A of the entitlement data 312 in an unencrypted format according to an embodiment herein. The entitlement data 312 includes the end user information 402, and a license file 404. The end user information 402 and the license file 404 are embedded/imprinted within the one or more software components 306 of the software products 316A-B. The end user information 402 may include one or more details/information such as:
Customer Name: ABC, Corp
Customer Address: 1700 XYZ Street, Santa Clara, Calif. 90505, USA
Company Web Domain Name: XXXXX.com
Customer Location: Latitude/Longitude Data
Contracts Language: XXXXXXXXXXXXXXXXXXXXXXXX
Length of Contract Terms: Valid until 31 Dec. 2020
Users Names (individual users who will use the software): Harry, John, etc.
Hardware Details (where software will be used): personal computer/Network/Cloud/etc.
Functionalities enabled in the Software product: FUNCTIONALITY-A, FUNCTIONALITY-B, etc.
Time Validity of each functionality: FUNCTIONALITY-A—31 Dec. 2020
FUNCTIONALITY-B—31 Jul. 2015, etc.

The license file 404 includes information related to the software products (e.g., the software product 316A-B). The license file 404 may further include information related to one or more software products that are different from the software products 316A-B. The license file 404 may include details such as:
PRODUCT A—FUNCTIONALITY-A—Quantity=10
VALID=31 Jul. 2020
VER=6.0 XXXXXXXXXX on a personal computer/a Network/or over cloud/etc.
PRODUCT A—FUNCTIONALITY-B—Quantity=5
VALID=31 Jul. 2015 VER=5.0 XXXXXXXXXX on the personal computer/the Network/over the Cloud, etc.
PRODUCT B—FUNCTIONALITY-X—Quantity=15
VALID=31 Jul. 2008
VER=5.0 XXXXXXXXXX a mobile communication device/a Network/or over cloud/etc.

The details may further include such as: (i) the software products and associated software components that can be used within a particular computing environment (e.g., in a particular operating system), (ii) a number of instances the software products and associated software components can be used at any given time, (iii) a time validity of the software products and associated software components, (iv) related sub-functionalities of the associated software components that can be invoked when operating the software products, (v) various versions that are allowed within a particular hardware infrastructure or the particular computing environment (e.g., the one or more computing environment 320A-N), and (vi) controls the software products and the associated software components based on contract terms and conditions.

With reference to FIG. 4A, FIG. 4B illustrates an exemplary view 400B of the entitlement data 312 in an encrypted format according to an embodiment herein. The end user information 402 and the license file 404 are encrypted and digitally signed using a private key to obtain the entitlement data 312 in the encrypted format. The entitlement data 312 may be encrypted using one or more available symmetric/asymmetric encryption algorithms, in one example embodiment. The encrypted format of the entitlement data 312 may include details such as:
Symmetric Key: XXXXXXXXX
Asymmetric Key: Public Key=XXXX
Encrypted Entitlement data Code: XXXX-XXXX-XXXX-XXXX-XXXX-XXXX
XXXX-XXXX-XXXX-XXXX-XXXX-XXXX
Software Component Digital Signature:
Entitlement data monitoring module Signature: XXXX-XXXX-XXXX-XXXX
Encrypted entitlement data Signature: XXXX-XXXX-XXXX-XXXX
Digital signature for a read only section: XXXX-XXXX-XXXX-XXXX
Digital signature for a read write section: XXXX-XXXX-XXXX-XXXX
Digital signature for a other header sections: XXXX-XXXX-XXXX-XXXX
Digital signature for an instruction section: XXXX-XXXX-XXXX-XXXX.

In one embodiment, the entitlement data 312 of the one or more software components 306 is prevented from tampering or modification by calculating digital signatures of at least one of the following (i) entitlement data monitoring module 314 to be inserted into the one or more software components 306, (ii) encrypted entitlement data, (iii) read only section of the one or more software components 306, (iv) read write section of the software component, (v) other header sections in the one or more software components 306, and (vi) instruction sections of the one or more software components 306 before and after imprinting the entitlement data monitoring module 314.

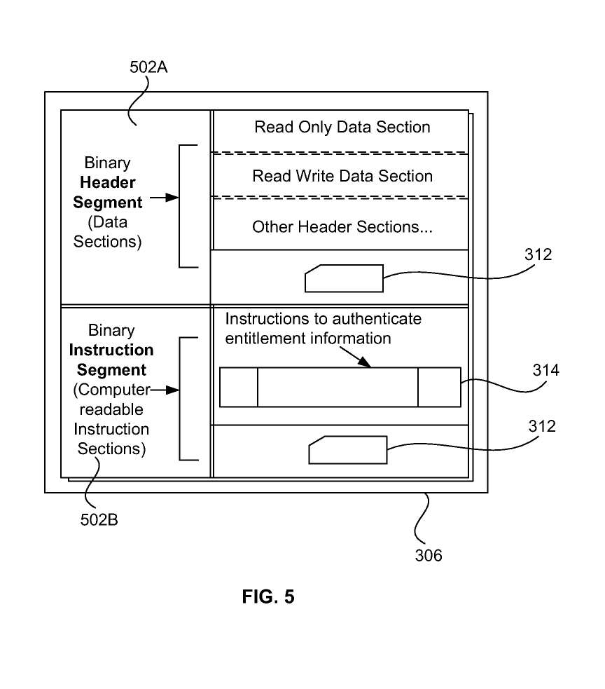

With reference to FIG. 3, FIG. 5 illustrates an exploded view of the one or more software components 306 according to an embodiment herein. The one or more software components 306 includes a binary header segment (data sections) 502A, and a binary instruction segment (computer readable instruction sections) 502B. The data sections 502A include a read only data section, a read write data section, and other header sections, etc. The end user information 402 and the license file 404 that are digital signed may be imprinted either in (i) the binary header segment 502A, or (ii) the binary instruction sections 502B, or (iii) both the sections. The end user information 402 and the license file 404 may be imprinted either in (i) the binary header segment 502A, or (ii) the binary instruction segment 502B, or (iii) both the sections without having to be encrypted or digitally signed, in one example embodiment. Similarly, the entitlement data monitoring module 314 may be imprinted in the binary instruction segment 502B.

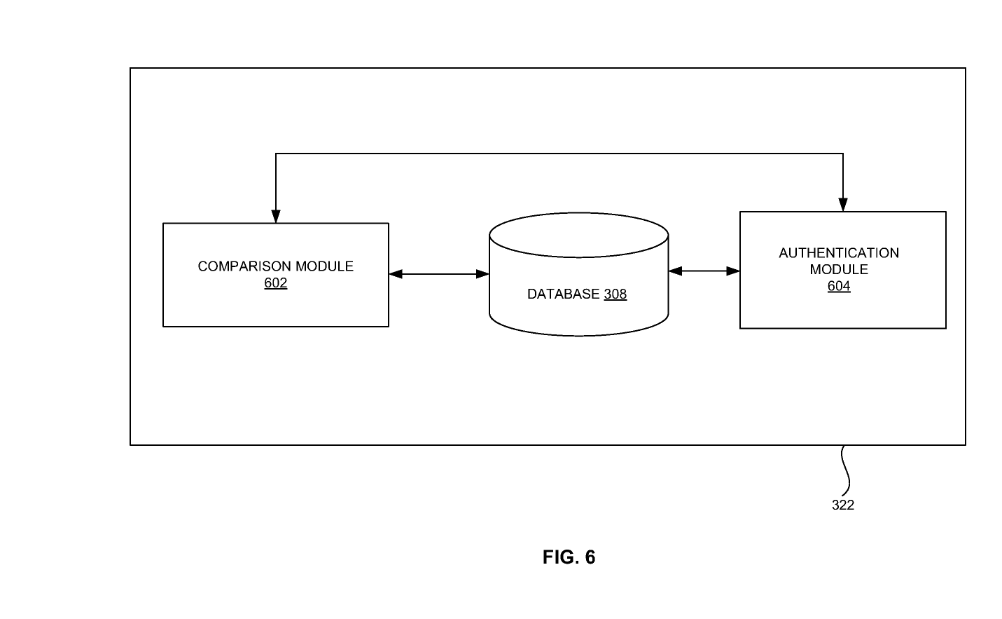

With reference to FIG. 3, FIG. 6 illustrates an exploded view of the entitlement data validation system 322 according to an embodiment herein. The entitlement data validation system 322 includes the database 308, a comparison module 602, and an authentication module 604. The database 308 stores (i) the entitlement data monitoring module 314, (ii) the entitlement data 312 such as contract terms and conditions, (iii) a usage statistics of the one or more software components 306, and a set of rules. The database 308 may further store an entitlement data associated with other software products that are either stored and/or executed on the one or more computing environment 320A-N. The comparison module 602 is configured to verify the entitlement data 312 received from the one or more computing environment 320A-N with information (e.g., the end user information 402 and the license file 404) stored in the database 308. The entitlement validation system 322 may include a decryption module for decrypting the entitlement data 312 which are digitally signed. The comparison module 604 validates the digitally signed entitlement data 312 using one or more public/private keys and decrypts the entitlement data 312. The entitlement data 312 may be (i) digitally signed using one or more private encryption keys, and (ii) decrypted using one or more public encryption keys. The comparison module 604 verifies whether the requested the software product 304 is authenticated to be used in the one or more computing environment 320A-N. The authentication module 604 authenticates the entitlement data 312 when it is invoked at the one or more computing environment 320A-N. In one embodiment, when the entitlement data 312 matches with the information stored in the database, then the authentication module 604 transmits one or more instructions to execute the software product 304 within the one or more computing environment 320A-N.

In one another embodiment, when the entitlement data 312 does not match with the information stored in the database 308, then the authentication fails and/or incorrect resulting in counterfeit entitlement data. The authentication module 606 transmits a message to the one or more computing environment 320A-N. The message may include a behavior of the software product. During the execution of the software product 304, when the entitlement data 312 does not match with the information stored in the database 308, the execution may either (i) continue in a normal state/condition, (ii) enable or disable (a) a sub-set of functionalities among a set of functionalities, or (b) the set of functionalities, and/or (iii) automatically terminate the execution of the software product.

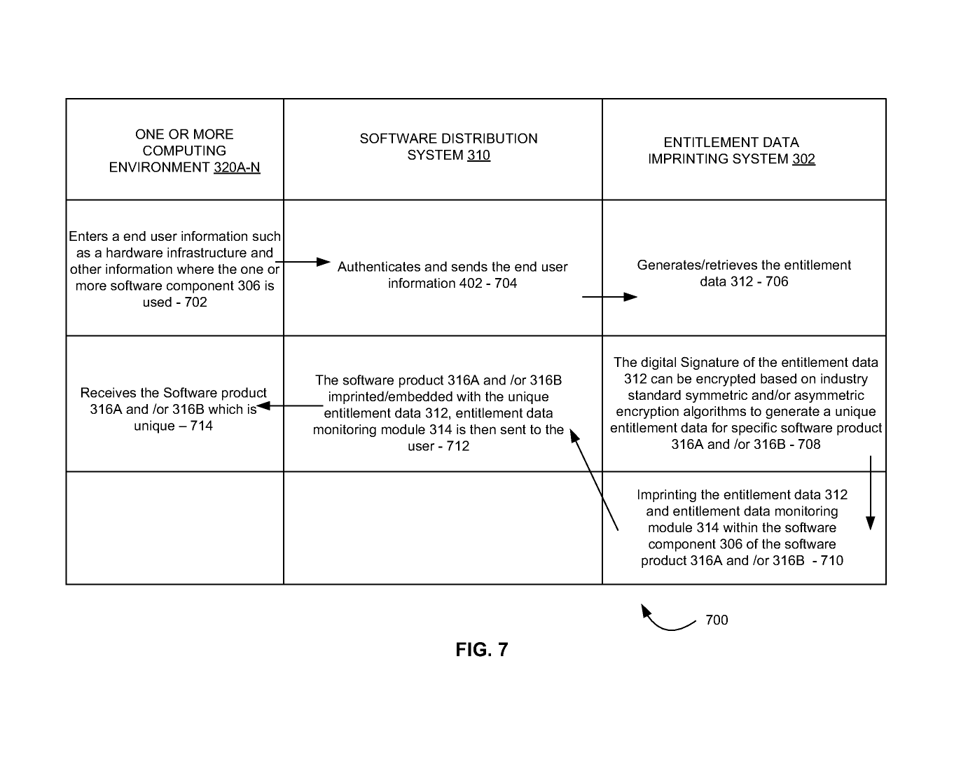

With reference to FIG. 3 through FIG. 6, FIG. 7 is an interaction diagram illustrating a method of creating a software product 304 based on an information received from the computing environment 320A-N according to an embodiment herein. The interaction diagram 700 includes a series of operations carried out during various stages of interaction between the one or more computing environment 320A-N, the software distribution system 310, and the entitlement data imprinting system 302. In operation 702, the user of the one or more user devices 318A-N provides details such as the end user information 402 such as a hardware infrastructure and information associate with the one or more computing environment 320A-N within which a software product will be executed.

In operation 704, the end user information 402 is authenticated by the software distribution system 310 and is transmitted/communicated to the entitlement data imprinting system 302. In operation 706, the entitlement data imprinting system 302 generates/retrieves the entitlement data 312. The entitlement data imprinting system 302 may obtain the entitlement data 312 from the third party system, in one example embodiment. In operation 708, the entitlement data 312 may be encrypted/digitally signed to correspond to a specific software product (e.g., the software product 316A and/or the software product 316B). In operation 710, the entitlement data 312 and the entitlement data monitoring module 314 are imprinted within the software component 306 or within the software product 316A and/or the software product 316B. In operation 712, the software distribution system 310 delivers the software product 316A and/or the software product 316B (e.g., with the entitlement data 312 and the entitlement data monitoring module 314 being imprinted) to the one or more computing environment 320A-N, or to the one or more user device 318A-N, or to the user. In operation 714, the one or more computing environment 320A-N receives the software product 316A and/or the software product 316B which are unique to the user.

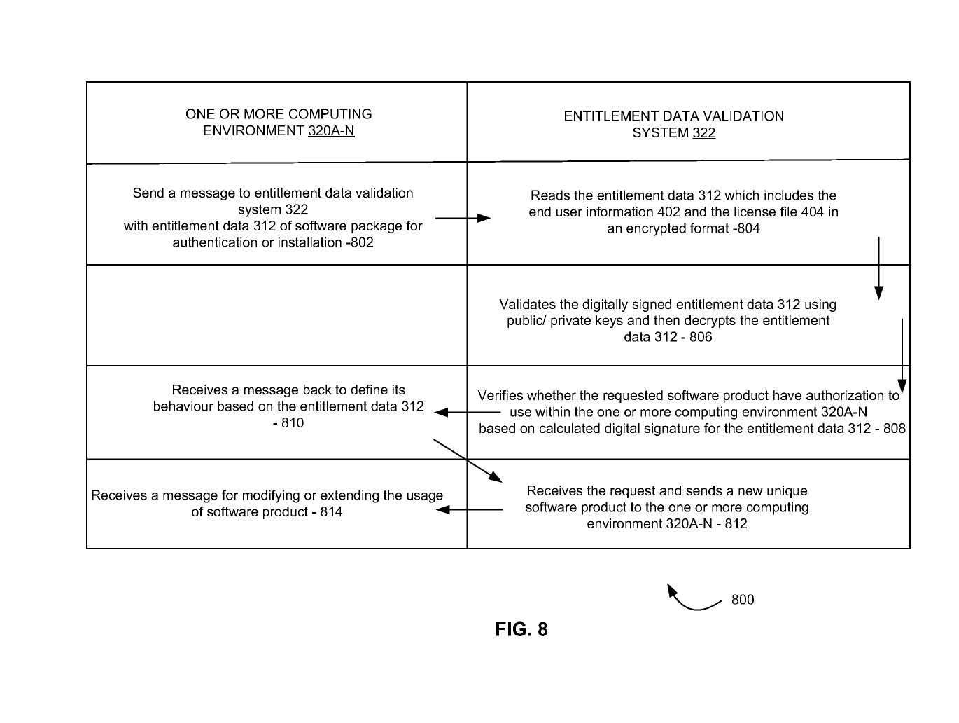

With reference to FIG. 3 through FIG. 7, FIG. 8 is an interaction diagram illustrating a method of authenticating the software product 304 during an execution within the one or more computing environment 320A-N according to an embodiment herein. The interaction diagram 800 includes a series of operations carried out during various stages of interaction between the one or more computing environment 320A-N, and the entitlement data validation system 322. In operation 802, the entitlement data monitoring module 314 transmits an entitlement data to the entitlement data validation system 322 for authentication/execution of the software product and associated one or more software components. The entitlement data includes the end user information 402 and the license file 404 that may be in an encrypted format or digitally signed. In operation 804, the entitlement data validation system 322 reads the entitlement data 312. In operation 806, the entitlement data validation system 322 validates the digitally signed entitlement data 312 received from the entitlement data monitoring module 314 and decrypts the entitlement data 312. In operation 808, the entitlement data validation system 322 verifies the entitlement data 312 with an information stored in the database 308 to determine whether the software product has an authorization to proceed with execution within the one or more computing environment 320A-N for use. In operation 810, the entitlement data monitoring module 314 receives a message from the entitlement data validation system 322. The message defines a behavior of the software product based on the entitlement data 312 received by the entitlement data monitoring module 314. The authorization may include (i) continue in a normal state/condition, (ii) enable or disable (a) a sub-set of functionalities among a set of functionalities, or (b) the set of functionalities, and/or (iii) automatically terminate the execution of the software product. In operation 812, the entitlement data validation system 322 (i) receives a request for another software product, and (ii) delivers a new unique software product to the one or more computing environment 320A-N only when at least one software component and its functionality is modified or extended beyond a description provided in the license file 404, or in a description file that describes a behavior of (i) the software product, at least one software component, and corresponding one or more functionalities of the at least one software component. In operation 814, a modified software product is delivered to the user/user device that may be executed on the computing environment.

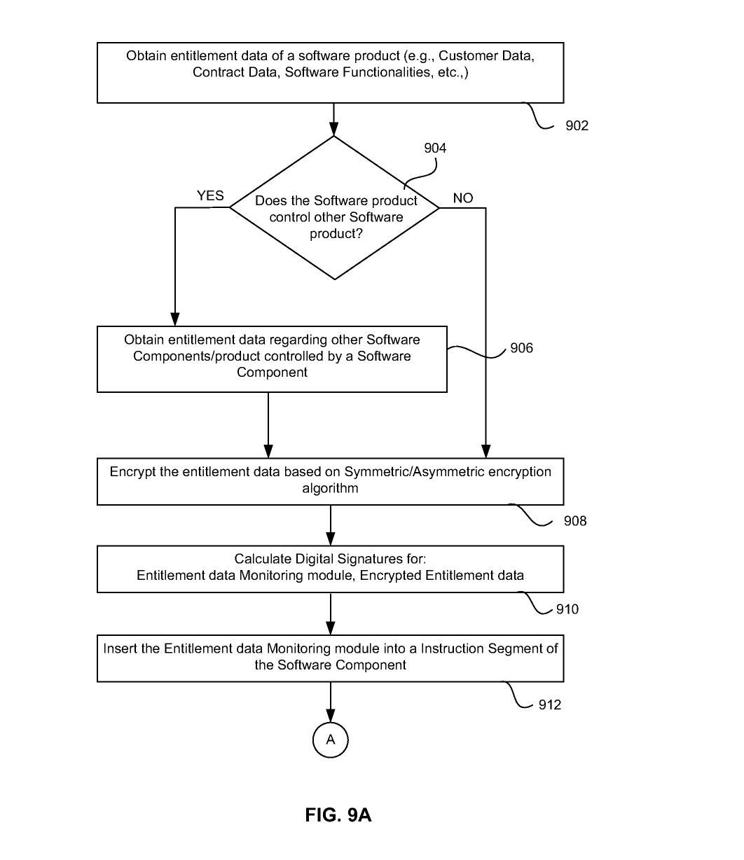

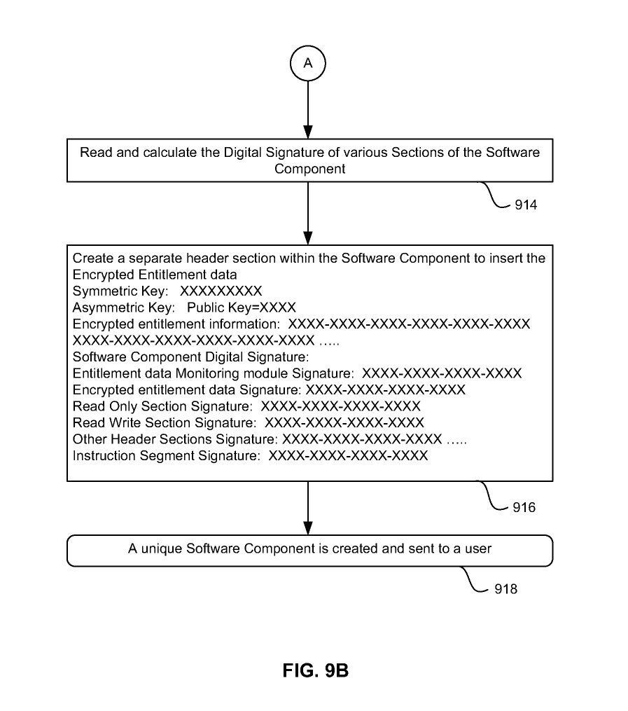

With reference to FIG. 3 through FIG. 8, FIGS. 9A & 9B is a flow diagram illustrating imprinting the entitlement data 312 and the entitlement data monitoring module 314 within the software product 304 according to an embodiment herein. In step 902, an entitlement data is obtained from a user and the database 308 for creating the software product 304. The entitlement data may include customer data, contract data, software functionalities, etc. In step 904, it is checked whether the software product requires to control other software products either in a same computing environment, or the other software product that are executed in a different computing environment. In step 906, an entitlement data of the other software products is obtained from the user and the database 308 if the software product requires to control other software products. In step 908, the entitlement data 312 is encrypted based on the one or more available symmetric/asymmetric encryption algorithm. If the software product does not control other software products, then the step 908 is performed. In step 910, digital signatures are calculated for the entitlement data monitoring module 314 and the entitlement data 312 in an encrypted format. In step 912, the entitlement data monitoring module 314 is imprinted into the binary instruction segment 502B of the software component 306. In one embodiment, the entitlement data monitoring module 314 may be inserted during compilation or build phase of the software product 304. In step 914, digital signature is calculated for various sections (e.g., a digital signature for a read only section, a digital signature for a read write section, a digital signature for other header sections, and a digital signature for an instructions segment section, etc.) of the software component 306. In step 916, a separate header section within the software component 306 is created for inserting/imprinting the entitlement data 312 in an encrypted format. The header section that is created separately may include information such as:
Information related Symmetric Key: XXXXXXXXX
Asymmetric Key: Public Key=XXXX
Encrypted entitlement information: XXXX-XXXX-XXXX-XXXX-XXXX-XXXX XXXX-XXXX-XXXX-XXXX-XXXX-XXXX
Software Component Digital Signature:
Entitlement data Monitor module Signature: XXXX-XXXX-XXXX-XXXX
Encrypted entitlement data Signature: XXXX-XXXX-XXXX-XXXX
Digital signature for the read only section: XXXX-XXXX-XXXX-XXXX
Digital signature for the read write section: XXXX-XXXX-XXXX-XXXX
Digital signature for the other header sections: XXXX-XXXX-XXXX-XXXX
Digital signature for the instruction segment section: XXXX-XXXX-XXXX-XXXX

In step 918, a unique software product is created and delivered to the user.

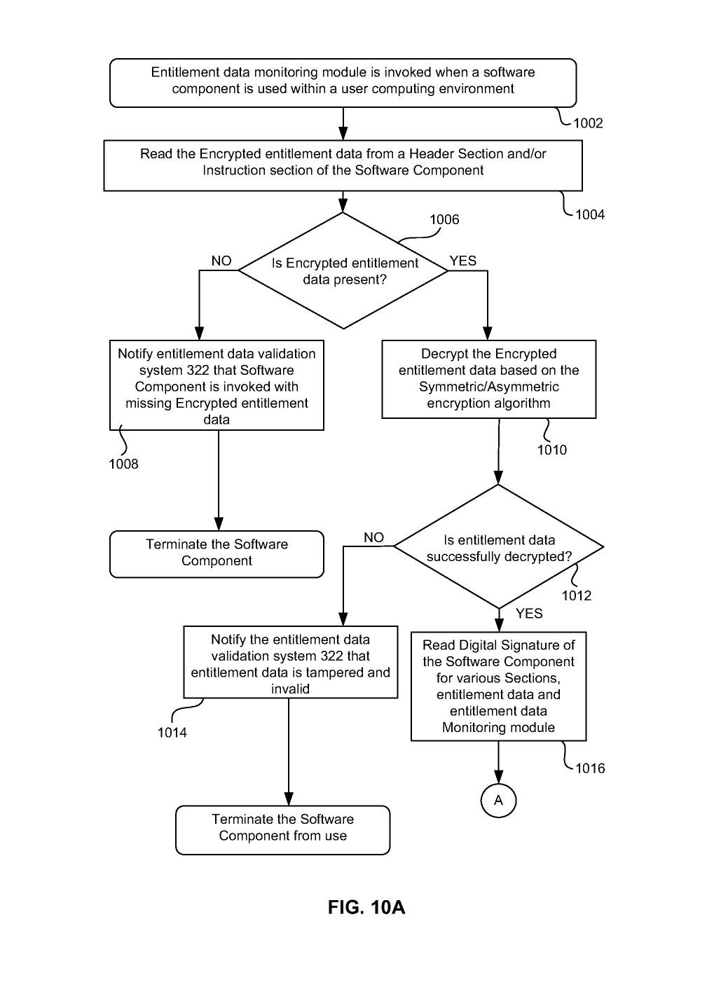

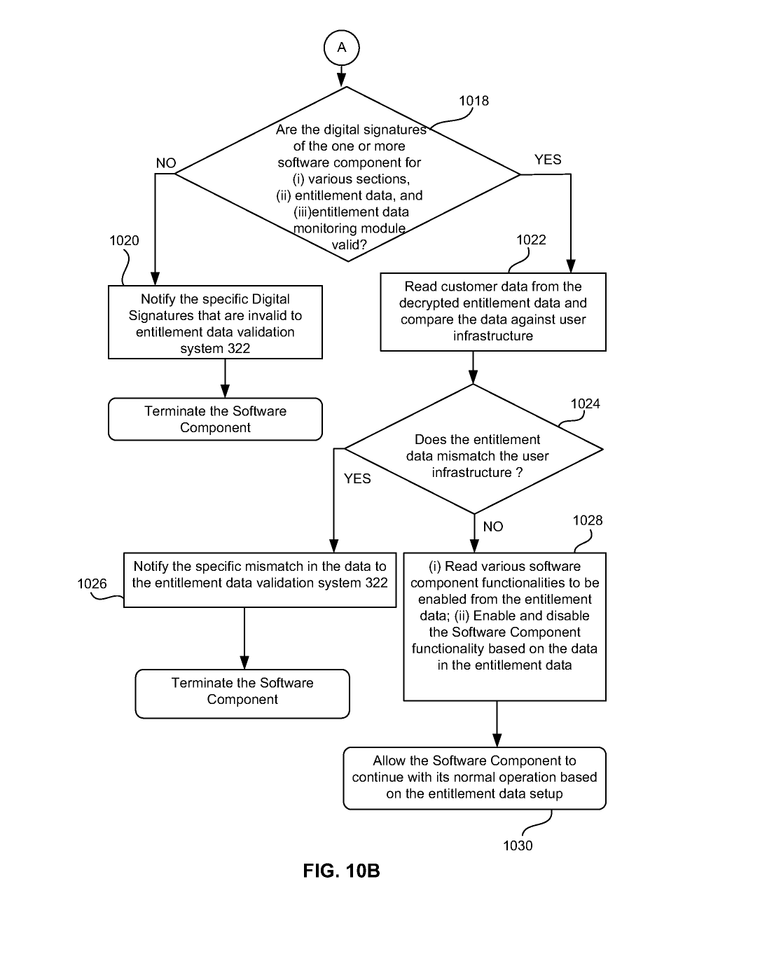

With reference to FIG. 3, FIGS. 10A and 10B is a flow diagram illustrating a method of authenticating the entitlement data 312 of the software component 306 in the one or more computing environment 320A-N according to an embodiment herein. In step 1002, the entitlement data monitoring module 314 is invoked during an execution of the software product 304 and the one or more software components 306 within the one or more computing environment 320A-N. In step 1004, the entitlement data 312 which is in an encrypted format is read from the binary header section 502A and/or the binary instruction segment 502B of the software component 306. In step 1006, it is checked whether the entitlement data 312 is present in the software component 306. In step 1008, if the entitlement data 312 is not present in the one or more software components 306, the entitlement data validation system 322 is notified about the entitlement data 312 not being present, and the execution of the software product 304 and the software component 306 may be terminated. In step 1010, if the entitlement data 312 is present in the one or more software components 306, the entitlement data 312 is decrypted using the one or more available public/private encryption algorithm. In step 1012, it is check whether the entitlement data 312 is successfully decrypted.

In step 1014, if the entitlement data 312 is not successfully decrypted, the entitlement data validation system 322 may be notified that the entitlement data is tampered and invalid, and the execution of the software product 304 and the software component 306 may be terminated. In step 1016, if the entitlement data 312 is successfully decrypted, digital signatures of the software component 306 is read for (i) various sections, (ii) the entitlement data 312, and the entitlement data monitoring module 314. In step 1018, it is checked whether the digital signatures of the one or more software components 306 for (i) various sections, (ii) the entitlement data 312, and the entitlement data monitoring module 314 are valid. In step 1020, if at least one digital signature is invalid, then the entitlement data validation system 322 is notified and the execution of the software product 304 and the software component 306 may be terminated. In step 1022, if the digital signatures are valid, then customer data is (i) read from the entitlement data 312 that is decrypted and (ii) compared with a hardware infrastructure associated with (i) the user, (ii) the user device, and/or the computing environment. In step 1024, it is checked whether the entitlement data 312 matches with the hardware infrastructure. In step 1026, if the entitlement data 312 does not match with the hardware infrastructure, then the representative (e.g., the entitlement data validation system 322) is notified and the execution of the software product 304 and the software component 306 may be terminated. In step 1028, if the entitlement data 312 matches with the hardware infrastructure, then (i) one or more functionalities of the software component 306 are read from the entitlement data 312 (ii) the one or more functionalities of the software component 306 are enabled or disabled based on the entitlement data 312. In step 1030, the execution of the software product 304 and the software component 306 are allowed to continue in its normal operation/state/condition based on the entitlement data 312.

Similarly, during an execution of the software product 304, the entitlement data monitoring module 314 that is present in the one or more software components 306 of the software product 304 can authenticate the execution of the software product 304 (e.g., the user software product have authorization to use within the one or more computing environment 320A-N) based on the entitlement data 312 without an intervention of the entitlement data imprinting system 302 and/or entitlement data validation system 322 or any other third party validation/authentication system. For example, if the entitlement data 312 authentication fails or incorrect then there exists a counterfeit entitlement data in the one or more software components 306. In one embodiment, the entitlement data monitoring module 314 sends a message (e.g., behavior of the user software product) to the one or more computing environment 320A-N through internet, email, telephony or any other electronic media.

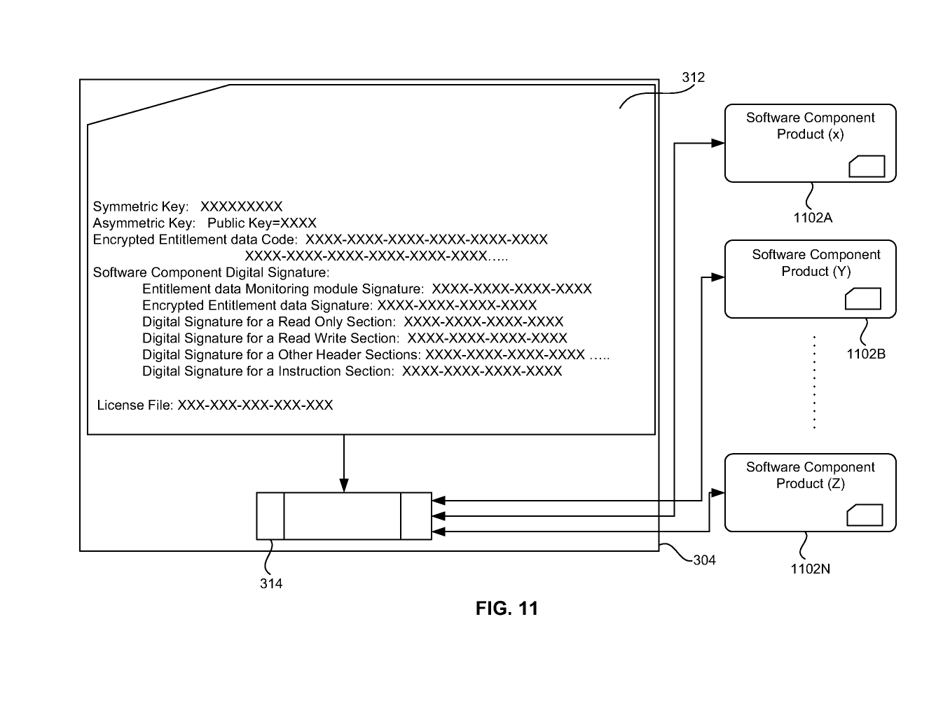

With reference to FIG. 4, FIG. 11 is a process view illustrating a method of authenticating other software products 1102A-N using the entitlement data 312 according to an embodiment herein. During an execution of the software product 304, the entitlement data monitoring module 314 that is present in the software component 306 of the software product 304 can authenticate the execution of the other software products based on the entitlement data 312 without an intervention of the entitlement data imprinting system 302 and/or the entitlement data validation system 322 or any other third party validation/authentication system. The entitlement data 312 may include the end user information 402 and the license file 404 associated with other software products. The entitlement data monitoring module 314 may also authenticate and/or validate legitimacy of the other software products 1102A-N within the same computing environment or within any other computing environment. For example, an entitlement data monitoring module 314 may be (i) imprinted in a first software product (e.g., an word processor or server type software product) and (ii) configured to execute the first software product and corresponding one or more software components in a first user device 318A (e.g., a personal computer) within a first computing environment 320A (e.g., the computing environment 320A). The entitlement data may include details associated with (i) a second software product (e.g., a PDF to word converter software product), (ii) a second user device 318B, (iii) a second computing environment 320B, (iv) a second hardware infrastructure, etc. The entitlement data monitoring module 314 may be configured to execute the second software product and corresponding one or more software components in (a) the first user device 318A within the first computing environment 320A, or (b) the second user device 318B (e.g., a mobile communication device) within the second computing environment 320B. The first computing environment 320A may be different from the second computing environment 320B, in one example embodiment. The first computing environment 320A may include a first operating system (e.g., a Windows operating system, or Linux operating System or Mac OS), in another example embodiment. The second computing environment 320B may include a second operating system (e.g., a Symbian™ operating system, an Android™ operating system, or any other operating system that is different from the first operating system). The entitlement data monitoring module 314 may enable and/or disable a sub-set of functionalities or a set of functionalities of the one or more software components of the other software products. The one or more software components of the other software products 1102A-N transmit a message to the entitlement data monitoring module 314 to authenticate the legitimacy of the use within the first computing environment 320A or the second computing environment 320B. In one embodiment, the other software products 1102A-N transmits environment data (e.g., product name, hardware infrastructure, a computing environment, a network name, a username, etc.) in an encrypted format. The entitlement data monitoring module 314 receives the encrypted environment data from the other software products 1102A-N and decrypts the message for interpretation. The entitlement data monitoring module 314 reads the data from the entitlement data 312 and compares with the message received from the other software products 1102A-N. The software product 304 sends a message in an encrypted format to define the behavior of the other software products 1102A-N. The first software product may send a message to the second software product regarding a behavior of the one or more software components in the second software product based on a comparison of the message with the entitlement information imprinted within the first software product. The first software product may be manufactured by a first manufacturer, in one example embodiment. The second software product may be manufactured by a second manufacturer who is different from the first manufacturer, in another example embodiment. Both, the first software product and the second software product may be manufactured by the first manufacturer, in yet another example embodiment. Both, the first software product and the second software product may be manufactured by the second manufacturer, in yet further example embodiment.

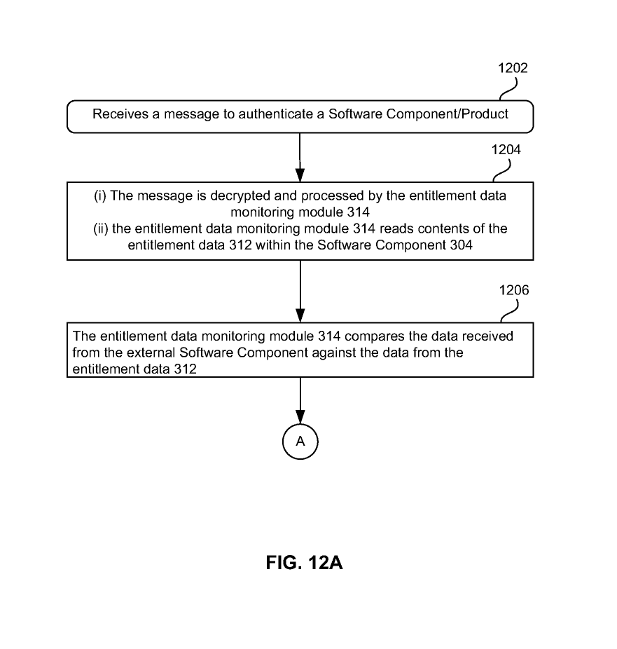

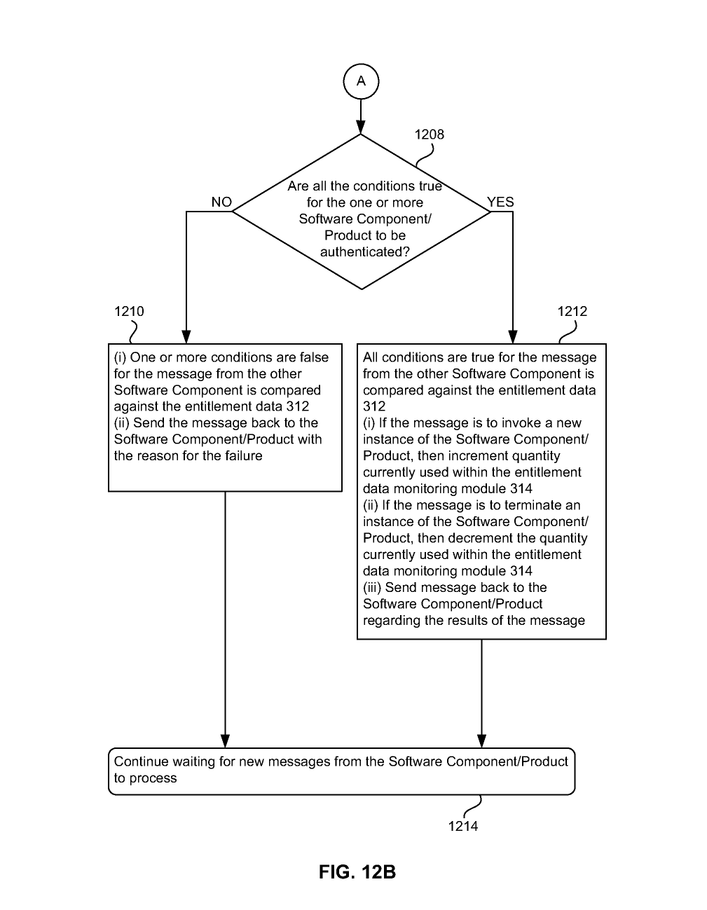

With reference to FIG. 11, FIGS. 12A and 12B is a flow diagram illustrating a method of authenticating and executing the other software products and associated the one or more software components, using the entitlement data monitoring module 314 of the software product 304 based on the entitlement data 312 according to an embodiment herein. In step 1202, the software product 304 or the entitlement data monitoring module 314 receives a message (e.g., in an encrypted format) from the other software products 1102A-N to authenticate during an execution. In one embodiment, the message may be received from the other software products 1102A-N when the execution is performed on the same hardware infrastructure or on a remote hardware infrastructure (e.g., over a network). In step 1204, (i) the message is decrypted, and (ii) content (e.g., an entitlement data) are read by the entitlement data monitoring module 314. In step 1206, the entitlement data monitoring module 314 compares the content received from the other software products 1102A-N against the entitlement data 312. For example, at least one of the following comparison may be performed: (i) it is checked whether the details associated with the other software products 1102A-N is present in the entitlement data 312 to authenticate, (ii) it is checked whether the one or more software components of the other software products 1102A-N are allowed to be used in a specific hardware infrastructure, (iii) it is checked whether the date is valid or expired) to use one or more functionalities of the one or more software components of the other software products 1102A-N, (iv) it is checked whether the number of instances of the other software products 1102A-N to be used exceeds than a quantity specified in the entitlement data 312, and (v) it is checked whether a particular version of the other software products 1102A-N can be used in the specific hardware infrastructure. In step 1208, it is checked whether all the conditions are true for the other software products 1102A-N and associated one or more software components to be authenticated. If at least one condition is not true, then a message is sent from the entitlement data monitoring module 314 to the other software products 1102A-N with a reason for a failure of authentication, in step 1210. In step 1212, if all the conditions are true based on the message received from the other software products 1102A-N, then at least one of the following operations may be performed: (i) invoke a new instance of the other software products 1102A-N and the associated one or more software components, then increment quantity currently used within the entitlement data monitoring module 314, (ii) terminate an instance of the other software products 1102A-N and the associated one or more software components, then decrement the quantity currently used within the entitlement data monitoring module 314, (iii) transmit/communicate a message to the other software products 1102A-N and the associated one or more software components regarding the results of the message. In step 1214, it may be continued to wait for new messages from the other software products 1102A-N and the associated one or more software components to process authentication.

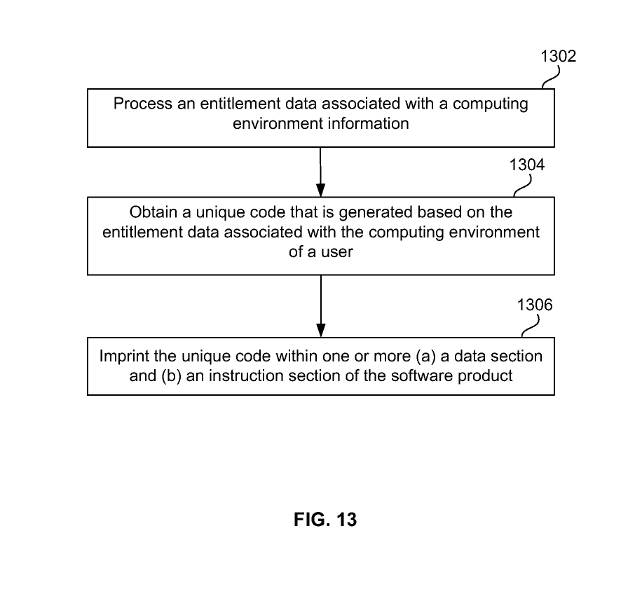

FIG. 13 is a flow diagram illustrating a method of imprinting an entitlement data 312 within the software product 304 according to an embodiment herein. In step 1302, the entitlement data 312 associated with computing environment information is processed from a user. In step 1304, a unique code that is generated based on the entitlement data 312 associated with a computing environment of a user is obtained. In step 1306, the unique code within one or more (a) the data section and (b) the instruction section of the software product 304.

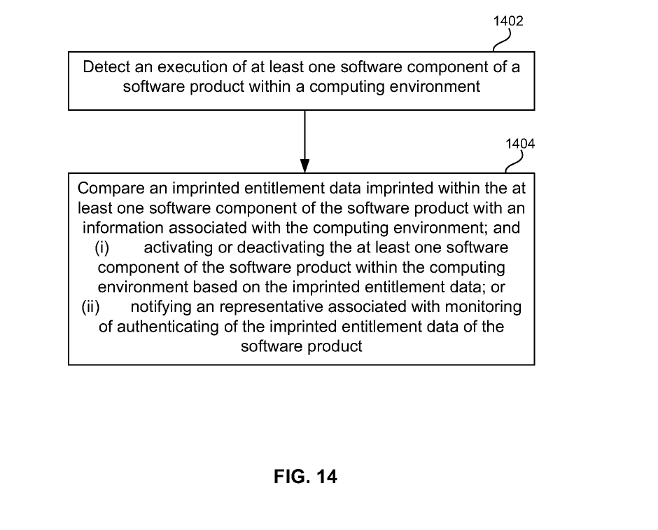

FIG. 14 is a flow diagram illustrating a method of authenticating entitlement data 312 imprinted within the software product 304. In step 1402, an execution of one or more software components of the software product 304 is detected within the computing environment. In step 1404, an imprinted entitlement data imprinted within the at least one software component of the software product is compared with an information associated with the computing environment. Further, (i) activating or deactivating the at least one software component of the software product within the computing environment based on the imprinted entitlement data, or (ii) notifying an representative associated with monitoring of authenticating of the imprinted entitlement data of the software product.

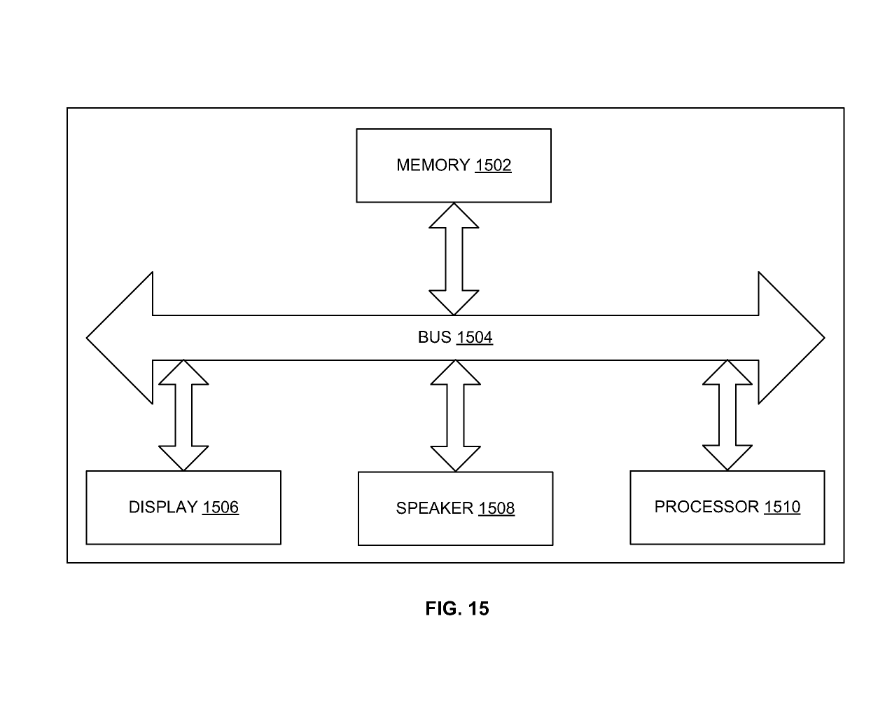

With reference to FIG. 3, FIG. 15 illustrates an exploded view of the user device 318B of FIG. 3 having an memory 1502 having a set of instructions, a bus 1504, a display 1506, a speaker 1508, and a processor 1510 capable of processing the set of instructions to perform any one or more of the methodologies herein, according to an embodiment herein. The processor 1510 may also enable digital content to be consumed in the form of video for output via one or more displays 1506 or audio for output via speaker and/or earphones 1508. The processor 1510 may also carry out the methods described herein and in accordance with the embodiments herein.

Digital content may also be stored in the memory 1502 for future processing or consumption. The memory 1502 may also store program specific information and/or service information (PSI/SI), including information about digital content (e.g., the detected information bits) available in the future or stored from the past. A user of the user device 318B may view this stored information on the display 1506 and select an item of for viewing, listening, or other uses via input, which may take the form of keypad, scroll, or other input device(s) or combinations thereof. When digital content is selected, the processor 1510 may pass information. The content and PSI/SI may be passed among functions within the user device using the bus 1504.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections).

In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

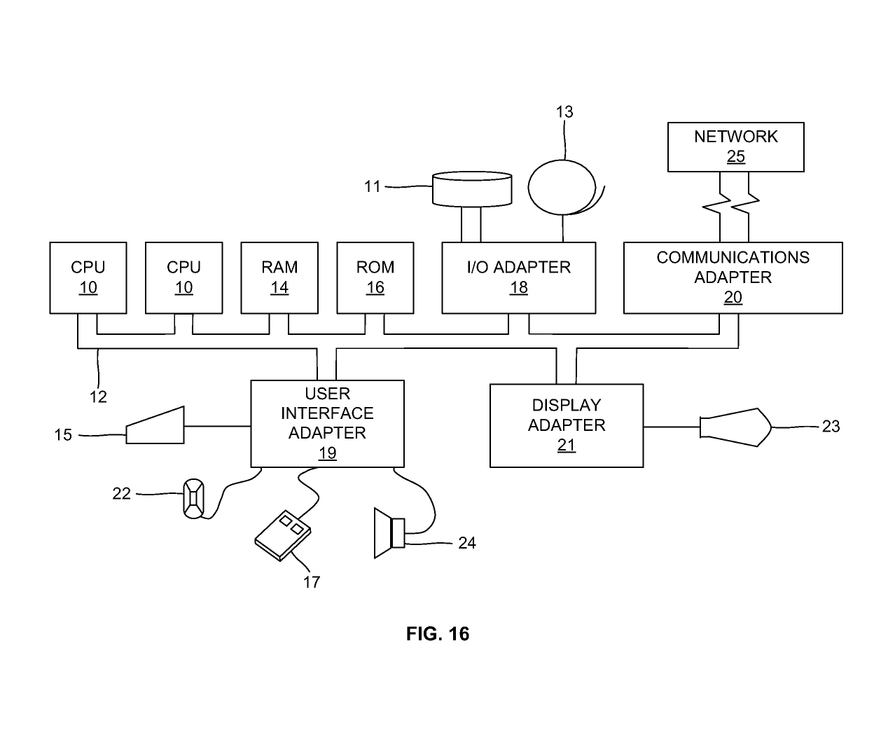

A representative hardware environment for practicing the embodiments herein is depicted in FIG. 16. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The entitlement data monitoring module 314 that is present in the one or more software components 306 of the software product 304 can authenticate the execution of the software product 304 based on the entitlement data 312 without an intervention of the entitlement data imprinting system 302 and/or entitlement data validation system 322 or any other third party validation/authentication system. The imprinting of the entitlement data 312 to define product behavior by the entitlement data validation system 322 are as a single entity, it becomes difficult for a hacker to create counterfeit version of software embedded with the product license file to work in a different computing environment from the one or more computing environment 320A-N illegally. In addition, the entitlement data validation system 322 also tries to authenticate for any tampering of the complete software module (both the Data section 502A and Instruction Section 502B), thus preventing a hacker from manipulating the entitlement data imprinting system 302 and/or entitlement data validation system 322 to create a counterfeit version. Each software component of the software product is authenticated and secure from infringement (e.g., each copy of the software product delivered to the user should be embedded with unique entitlement information). Hence, the software product is stolen by making a copy, and then the original entitlement information of the software product can be traceable. Similarly, in automobile industry, each vehicle manufactured is imprinted with a unique vehicle identification number (VIN) which helps in identifying theft in case a vehicle is stolen or dispute arises.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A software product unique to a user, comprising:
at least one software component that is executed on a computing environment associated with said user, wherein said at least one software component comprises a imprinted entitlement data that is imprinted within at least one of (a) a data section and (b) an instruction section, wherein based on a validity of said imprinted entitlement data, at least one of:
(i) said at least one software component of said software product is activated or deactivated; and
(ii) a representative associated with monitoring said validity of said imprinted entitlement data of said software product is notified.

2. The software product of claim 1, further comprising an at least one entitlement data monitoring module that is imprinted within said software product, wherein said entitlement data monitoring module is configured to authenticate said entitlement data for said execution of said at least one software component on said computing environment.

3. The software product of claim 2, wherein said at least one entitlement data monitoring module is imprinted within said instruction section of said at least one software component of said software product.

4. The software product of claim 1, wherein said at least one software component of said software product is continued to be executed in said computing environment and said representative is notified when said imprinted entitlement data is found to be invalid.

5. The software product of claim 1, wherein said entitlement data comprises:
i. information associated with said user;
ii. information associated with said computing environment;
iii. contract terms and conditions; and
iv. a validity period of said at least one software component of said software product or a plurality of other software product and associated software components within said computing environment.

6. The software product of claim 5, wherein said contract terms and conditions comprises:
i. an agreement associated with said software product;
ii. information to enable said at least one software component for a specific time period;
iii. said information to enable specific functionality of said at least one software component;
iv. said information to enable said at least one software component until termination of said agreement; and
v. said information to secure said at least one software component from tampering and illegal use.

7. A method of imprinting an entitlement data within a software product, comprising:
processing said entitlement data associated with a computing environment information, wherein said entitlement data comprises an end user information and a license file associated with said software product;
obtaining a unique code that is generated based on said entitlement data associated with a computing environment of a user ; and
imprinting said unique code within at least one of (a) a data section and (b) an instruction section of said software product, wherein said at least one entitlement data is unique to said user and said computing environment associated with said user.

8. The method of claim 7, further comprising imprinting, at said imprinting system, at least one entitlement data monitoring module within said software product, wherein said at least one entitlement data monitoring module is configured to authenticate said entitlement data for said execution of said at least one software component on said computing environment, or other software products and associated components within said computing environment.

9. The method of claim 7, further comprising imprinting said at least one entitlement data monitoring module within at least one instruction section of said software component of said software product.

10. A non-transitory program storage device readable by computer, and comprising a program of instructions executable by said computer to perform a method of authenticating an entitlement data imprinted within a software product, said method comprising:
detecting an execution of at least one software component of said software product within a computing environment;
comparing a imprinted entitlement data imprinted within said at least one software component of said software product with an information associated with said computing environment; and
(i) activating or deactivating said at least one software component of said software product within said computing environment based on said imprinted entitlement data; or
(ii) notifying a representative associated with monitoring of said authenticating of said imprinted entitlement data of said software product.

11. The non-transitory program storage device of claim 10, wherein said method further comprises continuing with said execution of said at least one software component of said software product in said computing environment when said representative is notified that said imprinted entitlement data of said software product is invalid.

12. The non-transitory program storage device of claim 10, wherein said imprinted entitlement data comprises at least one of (i) an end user information (ii) a license file, and (iii) combination thereof.

13. The non-transitory program storage device of claim 10, wherein said imprinted entitlement data is encrypted to authenticate and detect a tampering of said at least one software component.

14. The non-transitory program storage device of claim 10, wherein said imprinted entitlement data is imprinted within (i) at least one data section, (ii) at least one instruction section, or (iii) said at least one data section and said at least one instruction section.

15. The non-transitory program storage device of claim 12, wherein said license file comprises at least one of:
a. contract terms and conditions that comprises an entitlement contract expiration data;
b. a validity period of said at least one software component;
c. information associated with said software product and associated functionalities;
d. information associated with said computing environment;
e. information associated with a user;
f. information associated with a version of said software product; and
g. information associated with number of instances said software product to be used.

16. The non-transitory program storage device of claim 13, wherein said imprinted entitlement data of said software product is authenticated by:
a. extracting an encrypted imprinted entitlement data from said at least one software component;
b. verifying a digital signature of said imprinted entitlement data in said at least one data section and said instruction section by using a public encryption keys; and
c. decrypting said imprinted entitlement data for verifying tampering on said at least one software component, wherein said tampering is verified based on a digitally signed imprinted entitlement data of said software product.

17. The non-transitory program storage device of claim 10, wherein said activating or deactivating said at least one software component within said computing environment comprises decrypting said imprinted entitlement data to validate contract terms and conditions of said at least one software component;
a. deactivating said at least one software component from use by including a contract termination; or
b. notifying said representative associated with monitoring of said authenticating of said imprinted entitlement data of said software product.

18. The non-transitory program storage device of claim 10, further comprising activating or deactivating associated functionalities of said at least one software component of said software product based on decrypted imprinted entitlement data, wherein said imprinted entitlement data is decrypted to activate a subset of said associated functionalities within said at least one software component.

19. The non-transitory program storage device of claim 18, further comprising activating or deactivating specific functionalities within other software products and associated software components executed within said computing environment.

20. The non-transitory program storage device of claim 18, further comprising authenticating of entitlement expiration based on decrypted imprinted entitlement data, wherein said imprinted entitlement data is decrypted to deactivate said at least one software component and said subset of associated functionalities.
